(19) United States
(12) Patent Application Publication
(10) Pub. No.: US 2013/0197979 A1
(43) Pub. Date: Aug. 1, 2013

(54) ONLINE CONTENT MANAGEMENT

(71) Applicant: iOPW Inc., Toronto (CA)

(72) Inventors: Tae Ho HAN, Toronto (CA); Min Ho SON, Mississauga (CA)

(73) Assignee: IOPW INC., Toronto (CA)

(21) Appl. No.: 13/747,642

(22) Filed: Jan. 23, 2013

Related U.S. Application Data
(60) Provisional application No. 61/589,688, filed on Jan. 23, 2012.

(51) Int. Cl. G06Q 30/02

(52) U.S. Cl. CPC G06Q 30/0207
USPC 705/14.1

(57) ABSTRACT

A computer implemented method for managing content, comprising: receiving the content at a server, the content transmitted over a communication network from a member, the member having a profile comprising a plurality of variable characteristics, the profile stored in a database coupled to the server; categorizing the content into one of a pre-existing list of content categories and storing the categorized content into the database; publishing the content; receiving one or more ratings in response to publishing the content; updating one or more of the variable characteristics in the database to reflect the one or more ratings; and allocating a reward to the member for the published content, the reward commensurate with one or more of the plurality of variable characteristics.

### FIELD OF THE INVENTION

The present invention relates to online content, and in particular to generating, publishing and managing online content.

### BACKGROUND

The success of advertising and marketing and the visibility of a person or company's website is heavily influenced by the content on that website. For example, websites with relevant, high-quality content are usually considered more valuable by the public than similar websites with less relevant or lower quality content. Similarly, the more frequently that content on a website is updated, the more visibility a website will receive in terms of the quantity of accesses to the website.

Articles, photographs, videos and other content are typically created by specialists paid to create specific types of content in specific categories. Generally, business owners have little or no time to create or write content for his or her business website. Further, content for websites is typically created in one-off transactions: an author will create content and submit it for publication and will receive a payment in exchange. To hire a full-time writer or content creator can be prohibitively expensive for a small business owner.

### SUMMARY

According to an aspect of the present invention, disclosed is a computer implemented method for managing content, comprising: receiving the content at a server, the content transmitted over a communication network from a member, the member having a profile comprising a plurality of variable characteristics, the profile stored in a database coupled to the server; categorizing the content into one of a pre-existing list of content categories and storing the categorized content into the database; publishing the content; receiving one or more ratings in response to publishing the content; updating one or more of the variable characteristics in the database to reflect the one or more ratings; and allocating a reward to the member for the published content, the reward commensurate with one or more of the plurality of variable characteristics.

Further aspects of the above computer implemented method include one or a combination of any of the following features:
the step of publishing the content comprises at least one of: transmitting the content from the system to a client web page for publication; publishing the content on a web page accessible over the communications network; and publishing the content on a web page associated with the client, the web page accessible over the communication network.
the variable characteristics comprise a character identification and a level.
publishing the character identification together with the content.
the variable characteristics further comprise an avatar selected from a list of pre-determined avatars, the avatar of a member corresponds with the level of the member.
the step of receiving a rating comprises receiving a positive or negative rating transmitted over the communication network in direct response publishing the content.
receiving a member rating from a client, the member rating comprising a positive or negative rating of the member; and updating one or more of the variable characteristics of the member in response to receive the member rating, the updating commensurate with the member rating.
the step of updating comprises increasing the member's level in response to a positive rating and decreasing the member's level in response to a negative rating, and wherein the reward is commensurate with the member's level.
providing a chance reward to a selected member, wherein the probability of a member being selected is commensurate with one or more variable characteristics of that member.
adding a category to the list of pre-existing categories.
the step of categorizing comprises one of receiving a category selection from the member and allocating the content to a category.
one or more categories are restricted from a member's selection when the member has a level lower than a pre-determined cut-off level.
receiving further content at the server, the further content transmitted over a communication network from a sub-member, the sub-member associated with the member; categorizing the further content into one of a pre-existing list of content categories and storing the categorized content into the database; publishing the further content; receiving one or more ratings in response to publishing the further content; rewarding the member for the step of publishing the further content, the reward commensurate with the one or more ratings in response to publishing the further content.

According to a further aspect of the present invention, disclosed is a system for managing content, comprising: a server for receiving content, the content transmitted over a communication network from a member, the member having a profile comprising a plurality of variable characteristics; a database coupled to the server for storing the member's profile, the database for storing a category in association with the content, the category one of a pre-existing list of content categories; a central processor in communication with the server for transmitting data therebetween; a memory coupled to the central server, the memory having instructions and data stored thereon for execution by the central processor to configure the central processor to: publish the content; receive one or more ratings in response to the published content and update one or more of the variable characteristics in the database to reflect the one or more ratings; and allocate a reward to the member for the published content, the reward commensurate with one or more of the plurality of variable characteristics.

Further aspects of the above computer implemented system include one or a combination of any of the following features:
the variable characteristics comprise a character identification and a level.
the central processor is further configured to publish the character identification together with the content.
the variable characteristics further comprise an avatar selected from a list of pre-determined avatars, the avatar of a member corresponds with the level of the member.
the central processor is further configured to accumulate the ratings received and wherein the variable characteristics of the member are updated commensurate with the cumulative rating.
the central processor is further configured to allocate a chance reward to a selected member, wherein the probability of a member being selected is commensurate with one or more variable characteristics of that member.
the central processor is further configured to add a category to the list of pre-existing categories.
the central processor is further configured to receive the selected content category from the member over the communications network.
the central processor is further configured to: receive further content, the further content transmitted over a communication network from a sub-member, the sub-member associated with the member; categorize the further content into one of a pre-existing list of content categories and store the categorized content into the database; publish the further content; receive one or more ratings in response to publishing the further content; and allocate a reward to the member for the published further content, the reward commensurate with the one or more ratings in response to publishing the further content.

According to a further feature of the present invention, disclosed is a computer program product having computer readable code embodied therein, for execution by a central processor for configuring the central processor to: receive content at a server, the content transmitted over a communication network from a member, the member having a profile comprising a plurality of variable characteristics, the profile stored in a database coupled to the server; categorize the content into one of a pre-existing list of content categories and storing the categorized content into the database; publish the content; receive one or more ratings in response to publishing the content; update one or more of the variable characteristics in the database to reflect the one or more ratings; and allocate a reward to the member for the published content, the reward commensurate with one or more of the plurality of variable characteristics.

The concept of the present system is to create an interactive game-like online world with achievements and rewards for members. Members of the world maintain a character with a history of achievements and skills and are rewarded through multiple levels such as monetary and character development. A result of the system is that a large amount of categorized content is collected (whether in a centralized memory, server, or a cloud-based memory).

Embodiments of the present invention each have at least one of the above-mentioned aspects, but do not necessarily have all of them. It should be understood that some aspects of the present invention that have resulted from attempting to solve one or more of the above mentioned problems may satisfy other problems not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, in which:

FIG. 1 is a schematic diagram of a network infrastructure;

FIG. 2 is a schematic diagram of a system for managing content;

FIG. 3 is a schematic diagram of a database;

FIG. 4 is a diagram of a member page;

FIG. 4a is a screenshot of a member page;

FIG. 5 is a diagram of a client page;

FIG. 5a is a screenshot of a client page;

FIG. 6 is a diagram of a content posting page;

FIG. 6a is a screenshot of a content posting page;

FIG. 7 is a flow chart showing content publication;

FIG. 7a is a screenshot showing a client page with published content;

FIG. 7b is a screenshot showing a webpage with client information and published content;

FIG. 7c is a screenshot showing a webpage with the published content;

FIG. 8 is a flow chart showing the change in a member's level over time;

FIG. 9 is a flow chart showing the rewards a member receives for posting content; and

FIG. 10 is a flowchart illustrating the steps required to carry out a method of managing content.

### DETAILED DESCRIPTION

Described generally is a system that includes or comprises individuals who sign up as members to post content and receive rewards in response as well as business who subscribe as clients to receive the benefit of the posted content. Each member has a dynamic profile that is maintained by the system. The content posted by members and published by the system receives feedback and ratings from the public and from the clients. These feedback and ratings effect the member's profile, which in turn effects the rewards that member's receive for posting items of content. The term “post” as it appears herein may mean upload.

According to an aspect of the present invention, a computer implemented system and method for managing content is described. The system and method comprise: receiving the content at a server, the content transmitted over a communication network from a member, the member having a profile comprising a plurality of variable characteristics, the profile stored in a database coupled to the server; categorizing the content into one of a pre-existing list of content categories and storing the categorized content into the database; publishing the content; receiving one or more ratings in response to publishing the content; updating one or more of the variable characteristics in the database to reflect the one or more ratings; and, rewarding the member for the published content, the reward commensurate with one or more of the plurality of variable characteristics.

### Infrastructure

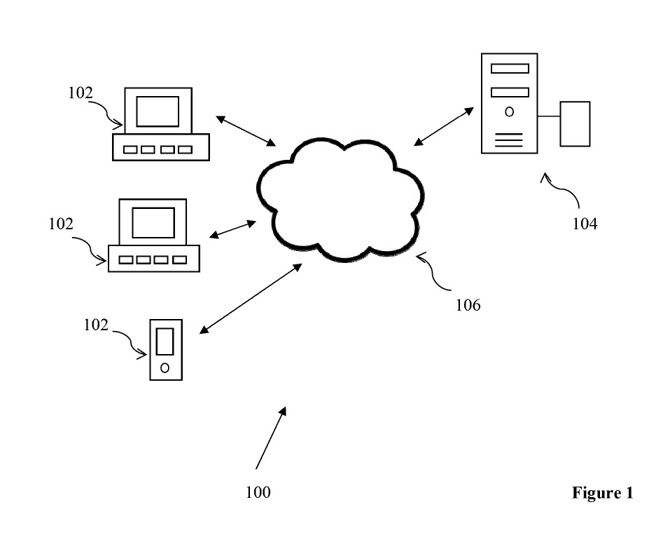

For convenience, like numerals in the description refer to like structures in the drawings. Referring to FIG. 1, a typical network infrastructure is illustrated generally by numeral 100. The network infrastructure 100 includes a plurality of computers 102, one or more network servers 104 and a communications network 106. Computers 102 can be mobile devices (e.g. handheld devices, smartphones, personal digital assistants), desktop computers, PCs, or other electronic device suitable for transmitting and receiving data across a network 100. Each computer has memory for storing instructions and a central processing unit for executing the instructions stored on memory.

The computers 102 communicate data to the network servers 104 and vice versa via the communication network 106. The communication network 106 may include several components such as a wireless network, a relay, a corporate server and an email server, for example.

The network servers 104 include servers such as a Web server, an application server, and an application server with web services, for example. It will be appreciated by a person of ordinary skill in the art that the network infrastructure 100 described herein is exemplary and that changes may be made to one or more components to accommodate different network configurations without affecting the scope of the aspects described herein. As noted below, the network server 104 is a component of the present system for managing content.

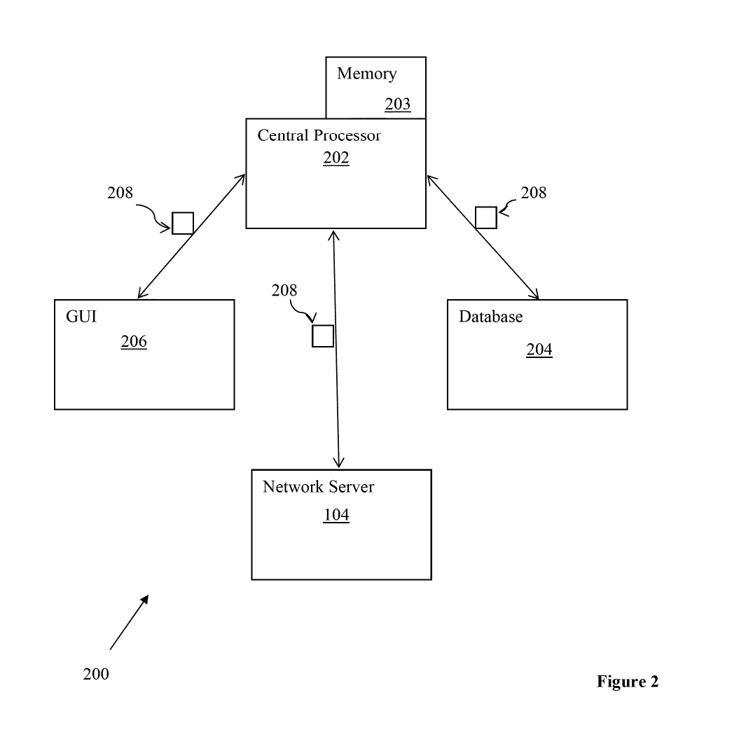

Referring to the exemplary embodiment shown in FIG. 2, a schematic diagram of an embodiment of the computer implemented system for managing content is illustrated by numeral 200. The system 200 includes a central processor 202 with memory 203, a network server 104, a database 204 and a graphical user interface 206 (GUI). The central processor 202 executes instructions stored on memory 203. It is understood that the central processor 202 can be connected to one or more ports for receiving connections. For example, flash memory or other input/output devices such as printers or fax machines can be connected to the central processor 202. Data 208 is transferred between the central processor 202 and the network server 104, between the central processor 202 and the database 204, and between the central processor and the GUI 206. For example, the central processor 202 transmits data 208 to the network server 104 which in turn can transmit the data 208 over the network. The central processor 202 transmits data 208 to the GUI 206 for display to an end user. Similarly, the GUI 206 transmits data 208 received as input to the central processor 202. Finally, the central processor transmits data 208 to and from the database 202.

The network server 104 can receive data transmitted from one or more computers 102 or other servers 104 via the communications network 106. Similarly the network server 104 can transmit data to one or more computers 102 or other servers 104 via the communications network 106. The transmission of data across the communications network 106 can be performed using the TCP/IP communications protocol for example. It is contemplated that the communications network 106 is the Internet.

### Database

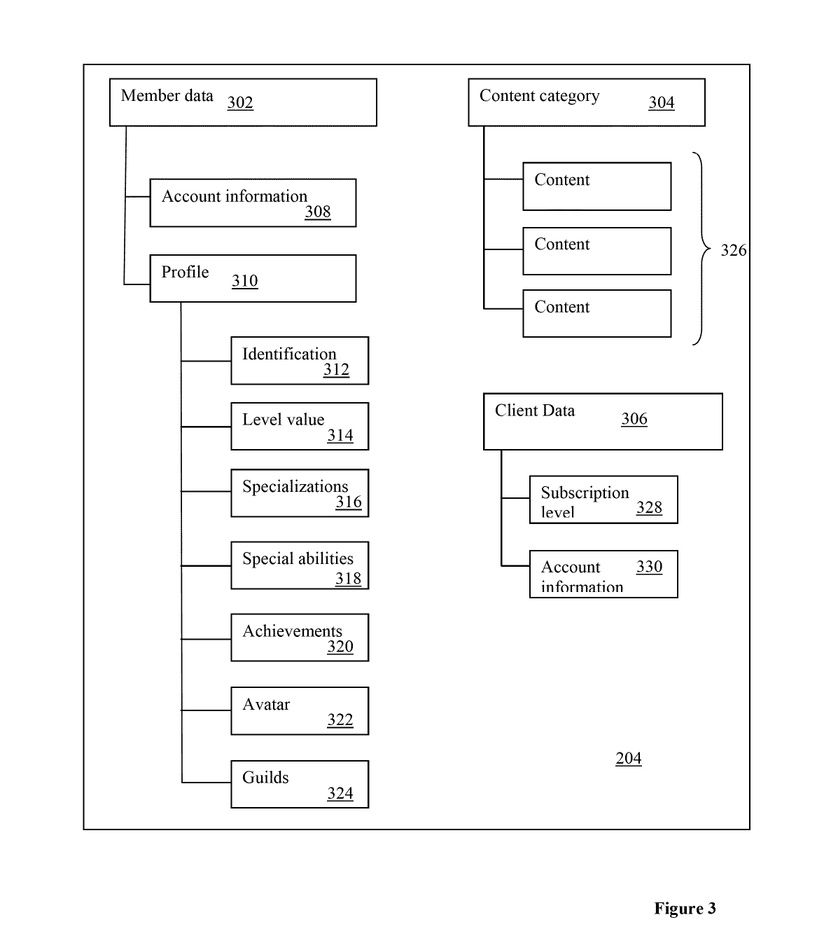

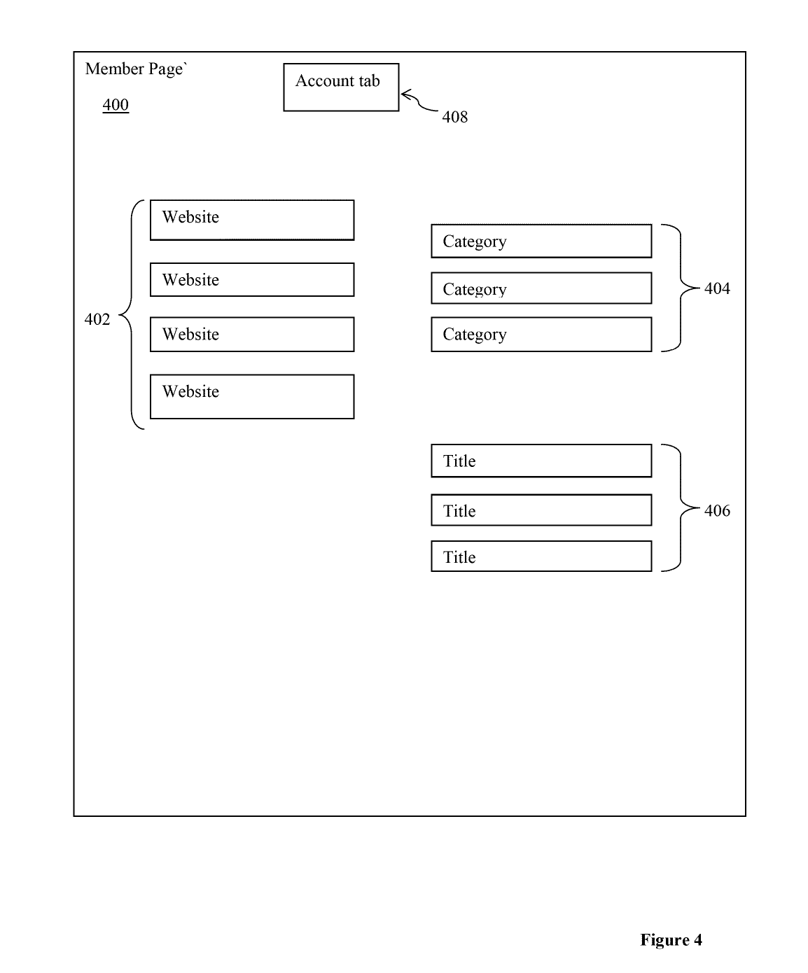

FIG. 3 is a schematic diagram of an embodiment of the database 204. The database 204 illustrated in FIG. 3 shows in schematic and hierarchical form the data components (or data fields) stored in the database 204. The database 204 stores member data 302, content categories 304 and client data 306. The member data 302 includes data for each member, such as member account information 308 and character profiles 310. Each character profile 310 contains one or more of the following variable characteristics (which comprise data and/or electronic files stored in memory): character identification 312, a level value 314, a list of category specializations 316, a list of special abilities 318, a list of achievements 320, an avatar 322 and a list of guild memberships 324. Each content category 304 includes links to all content 326 posted to that category 304. It is recognized that there can be a plurality of content categories 304 with each content category 304 having links to content 326 posted in that category 304. The client data 306 includes that client's subscription level 328 and the client account information 330.

In accordance with the illustrated embodiment, the database 204 can be accessed across the communications network 106. Access to the database 204 (e.g. for searching through data or editing data) is limited or protected. For example, the database 204 is password protected allowing for various levels of access including as administrative access, member access and client access. Administrative access allows full searching and editing capabilities of the data or searching access which only allows data searching capabilities. For example, searching can be done by a Boolean or key-word search term and can be restricting to searching within certain fields (e.g. within character profiles 310 or categories 304). Member access provides access to particular member account information 308, content posting history and provides an interface for posting new content. Client access provides access to particular client account information 330 and the history of content posted to the client's webpage. It is contemplated that the database 204 can be a distributed database such as a database distributed over the communications network 106 (e.g. in the “cloud”).

According to an embodiment, the database 204 is programmed in SQL. By way of further example, data 208 can be transmitted to and from the database using a structured language such as XML.

### Graphical User Interface (GUI)

The GUI 206 is accessible across the communications network 106 from a computer 102 connected to the network 106. When a party (e.g. a member or a client) accesses the system through the GUI 206 a login page is first displayed on the GUI 206. A party can log in (e.g. with a password and username) to the system 200 as a client or member in order to access client or member pages, respectively.

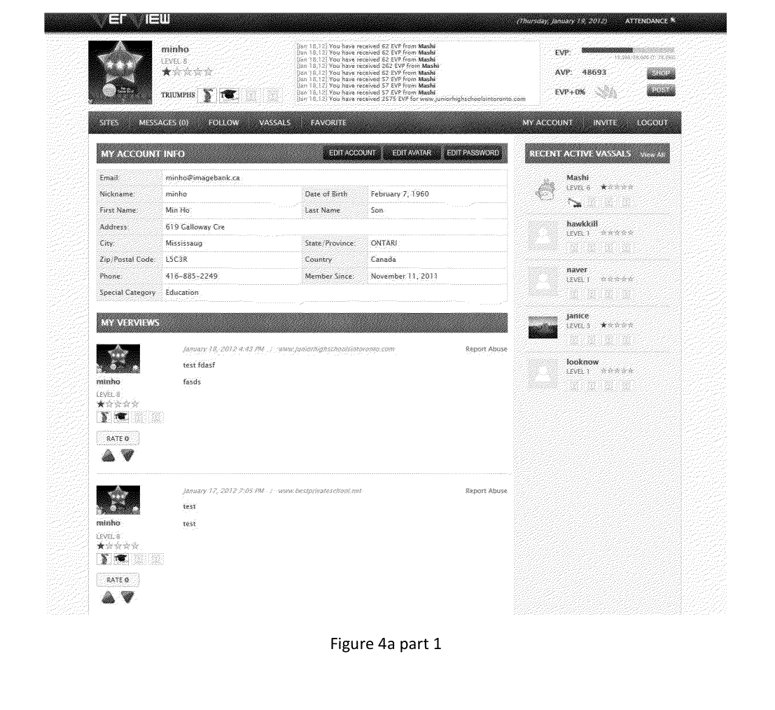

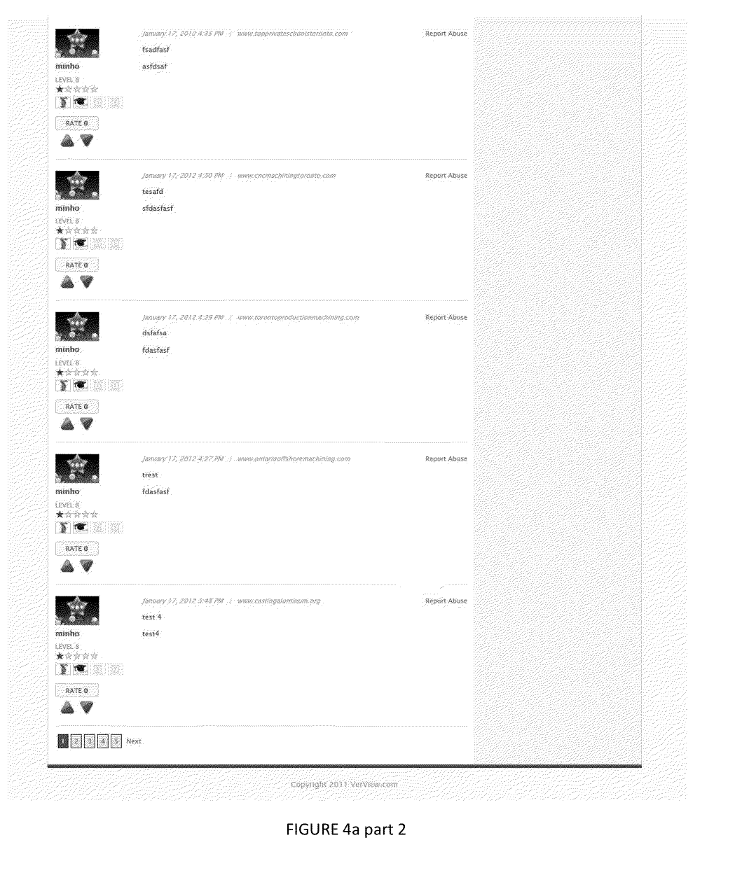

When a member logs into the system via the communications network 106, a member page is displayed to that member. The member page can be retrieved from the database 204, for example. Referring to FIG. 4, a schematic diagram of an embodiment of the member page is illustrated at numeral 400. The member page 400 shown in FIG. 4 illustrates in schematic form functional elements that are displayed on the member page 400. The member page 400 displays a list of selectable websites 402, a list of selectable categories 404 and a list of published content titles 406 for published content recently posted to the system. Each of the selectable websites 402, selectable categories 404 and content titles 406 are links to the respective website, category or content. When a link is selected the corresponding website, category or content is displayed on the GUI 206. The lists on the member page 400 can be scrollable if the item on the list does not appear on the page 400. It is contemplated that the member page 400 will be implemented on a webpage and that the links will be hyperlinks. FIG. 4a is an exemplary screenshot of the member page 400.

In accordance with the illustrated embodiment, a selectable account tab 408 is displayed on the member page 400. The account tab 408 is a link (e.g. hyperlink) to an account page within the system 200 that displays the contents of member's account information, such as address, name, email address and the like for that member, for example. This account information is retrieved from the database 204 by the central processor and is then sent to the GUI 206 to be displayed. The account information can be edited from this account page and it will then be transmitted by the central processor back to the database 206. The member's character name, avatar and list of category specializations are shown at the account page. The character name can similarly be edited from the account page.

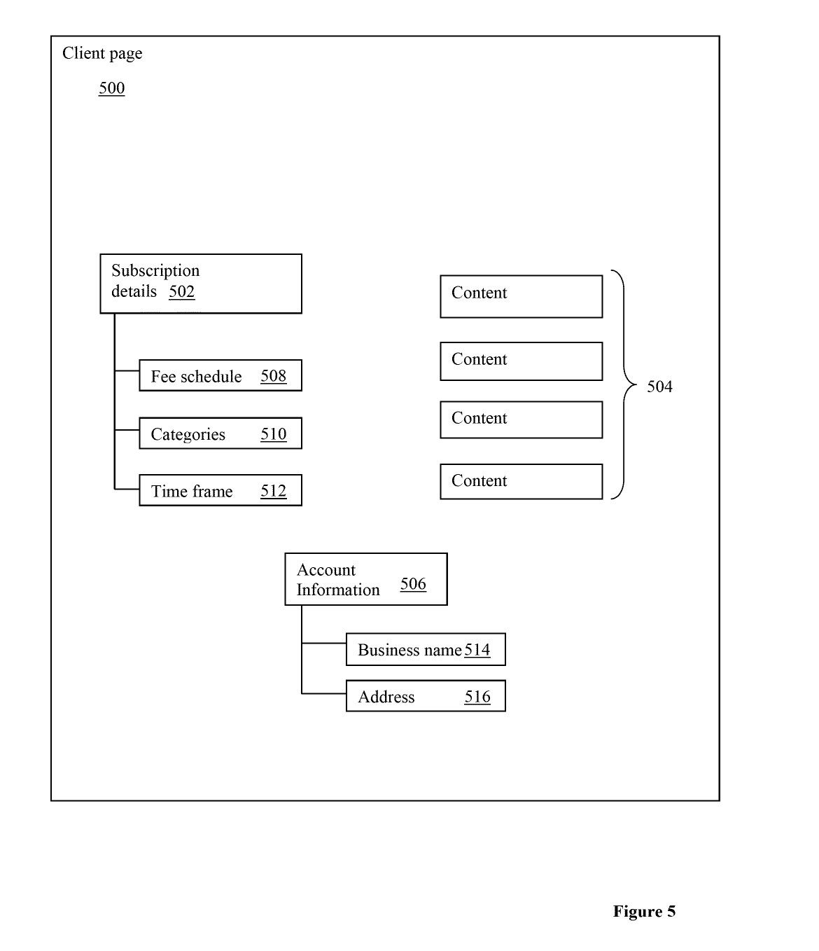

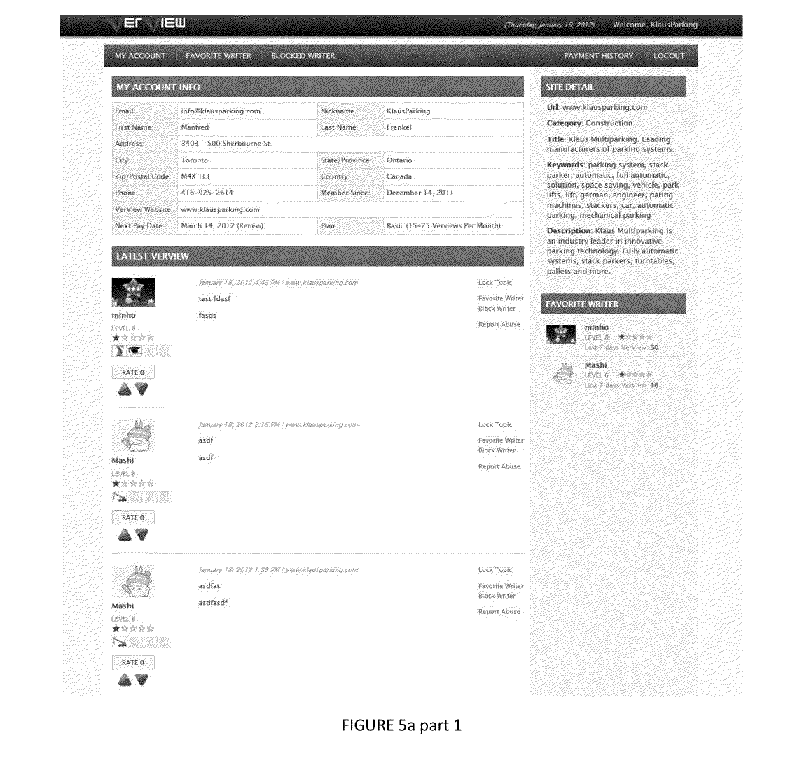

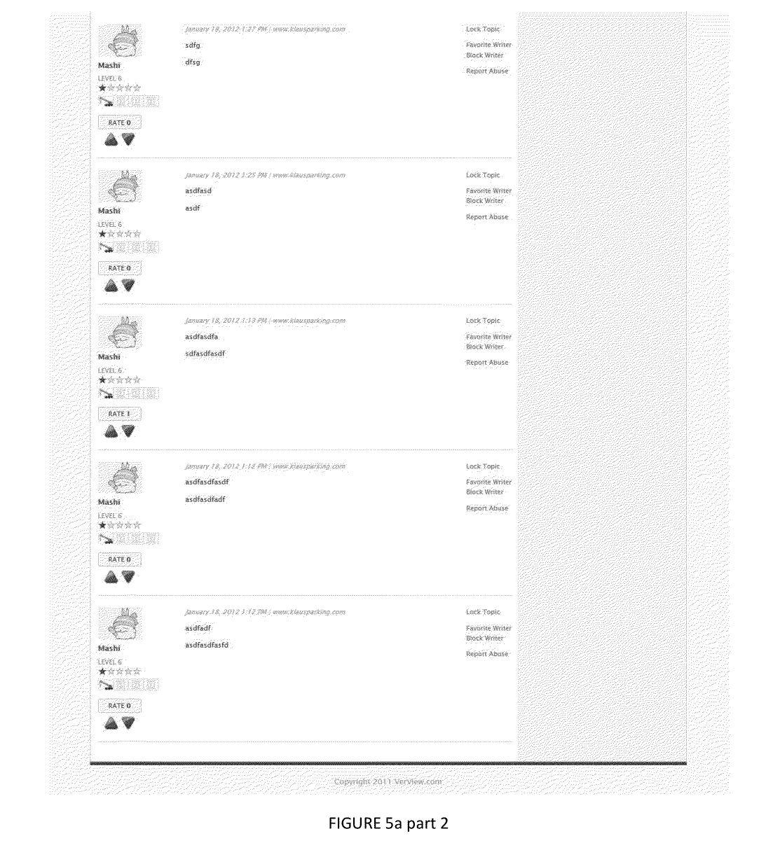

When a client logs into the system via the communications network 106, a client page is displayed on the GUI 206. For example, the client has a password that can be used to access the client page from the network server 104 across the network 106. With reference to FIG. 5, a schematic diagram of an embodiment of the client page is illustrated by numeral 500. For example, the client page 500 in FIG. 5 illustrates in schematic form functional elements that are displayed on client page 500. The functional elements are also displayed in hierarchical relationship in the client page 500 in FIG. 5. For example, the client page 500 includes the client's subscription details 502, titles of posted content 504 in the client's categories and the account information 506 for the client. The hierarchy of the subscription details 502 is as follows: the subscription details 502 includes the fee payment schedule 508 for the client, the list of categories 510 for which the client receives published content and the time frame 512 within which the client is to receive published content. The hierarchy of the account information 506 is as follows: the account information 506 includes the client business name 514 and address 516. Additional information can be shown on the client page 500 such as the client's selected favourite members and the client's selected banned members, for example. The information displayed on the client page 500 comprises links to data stored in the database 204. The links can be hyperlinks which when selected cause the central processor 202 to retrieve the respective data from the database 204 and display it on the GUI 206. For example, the titles of posted content 504 comprises a list of hyperlinks which when selected cause the respective posted content to be displayed on the GUI 206. FIG. 5a is an exemplary screenshot of the client page 500.

In accordance with the illustrated embodiment, the client page 500 has a submission form for providing ratings feedback on any member who published content that the client used in its website. These ratings are transmitted across the network 106 to the system 202 where the ratings are saved or stored in the database 204 in association with the member and have the effect of altering the member level (a value that is also stored in the database 204) to reflect the rating. The ratings can be accumulated in the database so that all client ratings are represented by a single client ratings value, which can then be used to determine whether the member's level is increased. According to an exemplary embodiment, the client rating is +1 for positive and −1 for negative. In an embodiment, the negative rating has more effect on the cumulative rating than the positive rating (for example, −2 for a negative rating and the +1 for a positive rating). In yet a further embodiment, clients who pay for certain subscriptions can have an increased rating such that a positive rating and a negative rating have a higher and lower respective value than the ratings from clients with other subscriptions.

The member page, account page and client page are coded in HTML, ASP.NET, Flash and Java and form part of the GUI 206. It is understood that different programming languages can be used to implement the present invention.

An administrator administers elements of the present system 200. When the administrator logs into the system 200, an administrator page is displayed on the GUI. The administrator can log into the system 200 via the communications network 106 in order to access the administrator page from the network server, for example. According to an embodiment of the present invention, the administrator has access to the client pages 500 for each client and the member pages 400 for each member. In an embodiment, the administrator can edit the data 208 accessible from the client pages 500 and member pages 400. By way of further example, the administrator can provide a rating to the member, which alters that member's level (e.g. a positive administrator's rating has a pre-determined percentage increase to a member's level).

### Members and Clients

An individual or party who has become a member of the system is given a password that can be used to access its member page 400 (i.e. membership access). It is through the member page 400 that the member can upload or post content to the system 200 and can amend or update its account information. When a person first becomes a member of the system he or she required by the system 200 to select a character name (e.g. by way of prompt in the member page 400). The character name is the name that is the public identifier for that member. For example, when a member publishes content, the content will be attributed to that member's character name. In another embodiment, the member can select an avatar that will also form part of that member's public character identification. The member can also select one or more categories for which it has a specialization. In an embodiment, the member's selection is limited to selecting only one category of specialization. In another embodiment, the member's selection is limited to making a selection of categories for which he or she has a specialization when he or first becomes a member. In yet a further embodiment, the system 200 (or administrator) assigns an avatar to a member who has posted a threshold number of content items to a specific category and who has a minimum cumulative rating for those articles. For example, a bulldozer icon or avatar can be assigned to a member who has posted 1000 or more content articles with a positive cumulative rating in the construction category. By way of further example, after an avatar or icon has been assigned to the member that member has the choice of using the icon when posting content in that category.

It is contemplated that a member could consist of an individual company, partnership or other business structure.

The system 200 stores each member's variable characteristics in the database 204. The values in one or more of a member's variable characteristics are altered by the system 200 (i.e. by the central processor 202 executing instructions on memory 203) in response to communications or feedback received on that member's activity or on any of the content posted by that member. It is understood that an administrator can alter the values in one or more of a member's variable characteristics manually using the administrator page.

Members can elect to become members of guilds with other members. Members of guilds can collaborate on content for certain categories, for which they both may receive rewards and for which they both may receive feedback. Further, members of guilds can rate each of the other guild members and this rating will have an effect on the rated members' levels. For example, if the sum of the ratings of a member from all other guild members is above a certain threshold than that member's level is increased by one or more. The elections to become a member of a guild and the rating of other guild members can be performed using the member page 400. Additionally, members of a guild can receive rewards for being a member of a guild with the most members and/or being a member of a guild with the highest cumulative rating.

A subscribing business (i.e. a client of the system) pays a monthly subscription fee in order to receive the benefits of content posted by members and published by the system 200. In an embodiment, there are two different levels of subscription that a client can subscribe to with each level of subscription providing the client with a correspondingly different level of service. In a further embodiment there are three different levels of subscription that a client can subscribe to with each level of subscription providing the client with a correspondingly different level of service. It is contemplated that different levels of subscription can be implemented.

In accordance with an embodiment, in order to receive the benefits of published content, a client selects a minimum of one category. Such a selection can be made through the client page. For example, the list of categories can be edited to insert the name of the categories for which the client will receive published content. According to an embodiment, upon selection of the list of categories a pop up window appears providing the list of categories available to that client for selection. The client can then select the categories which will then show up in that client's category list.

### Posting Content

A member can post content to the system 200 using the member page 400. To post content, the member first selects a category from the selectable list of categories on the member page 400. Alternatively, the member can use a search function on the member page 400 to find a category to post content in. For example, if a contemplated category is not shown in the member page 400 the member can use a key-word search or Boolean based search, known in the art, to search through all of the categories in the database 204.

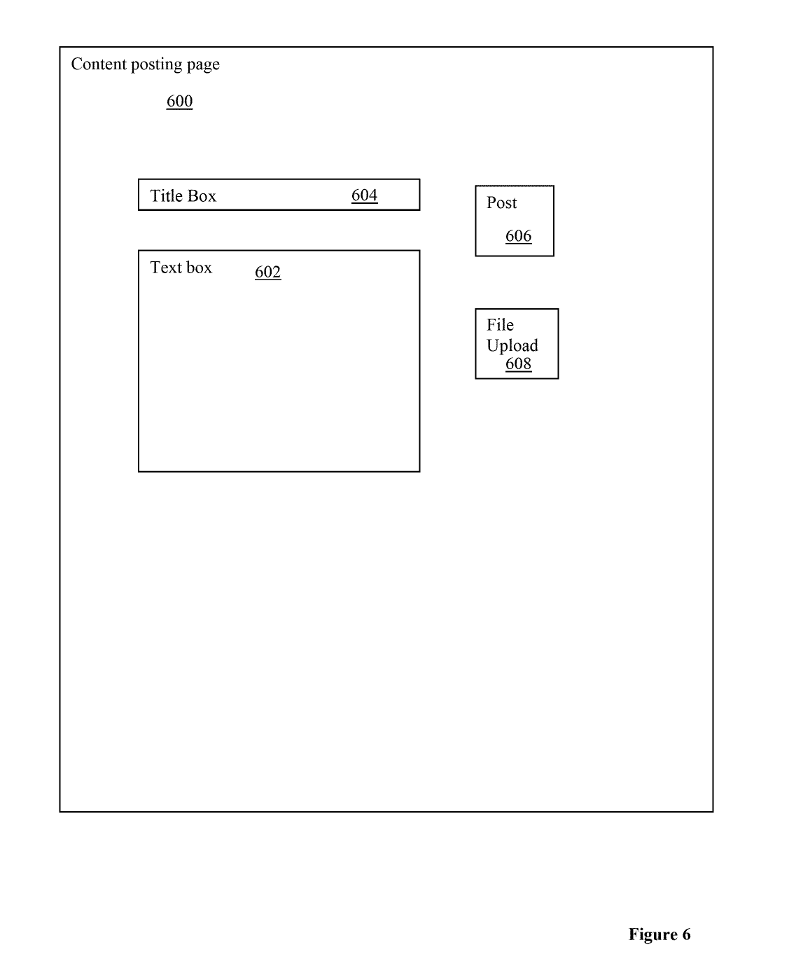

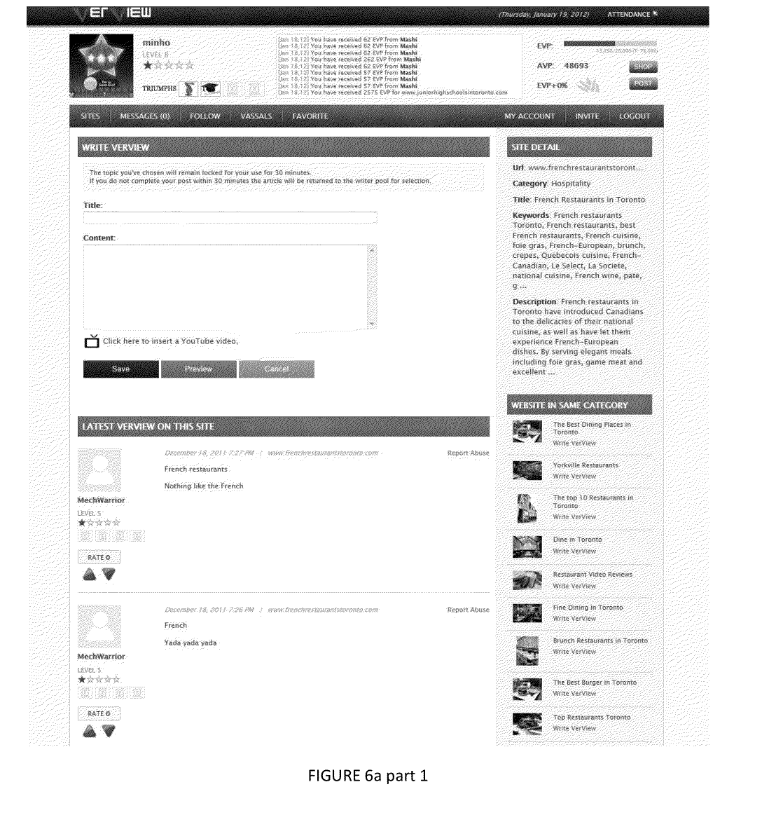

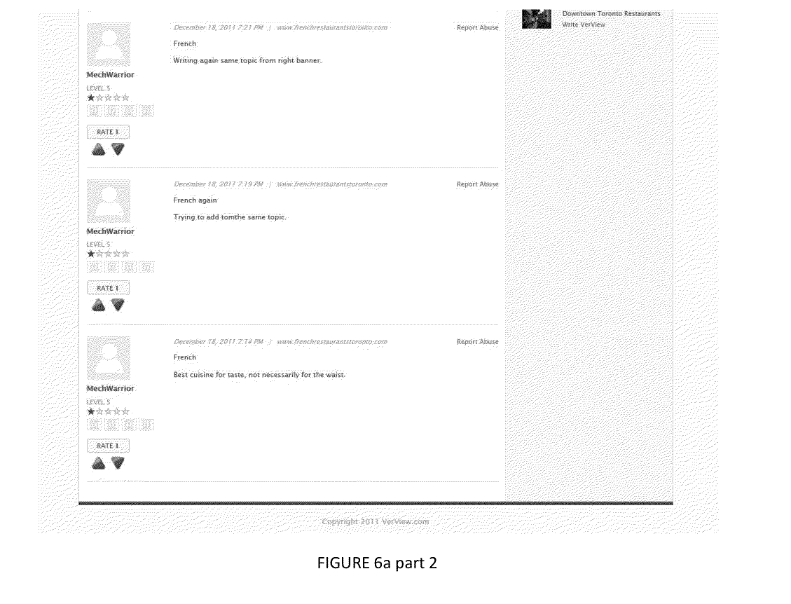

FIG. 6 is a schematic diagram illustrating an embodiment of a content posting page 600. More particularly, FIG. 6 shows one or more functional elements of the content posting page 600 in schematic form. When a category is selected (e.g. using the member page 400) a content posting page 600 is displayed on the GUI. According to an embodiment, the content posting page 600 has a text box 602, a title box 604, a post button 606 and a file upload button 608. Each of these elements (600, 602, 604, 606) may be considered functional. For example, content can be written or pasted into the text box 602 and, optionally, a title for the content can be written or pasted into the title box 604. When the post button 606 is selected, the content in the text box 602 is posted to the system 200 in association with the title in title box 604. Alternatively, a file can be uploaded to the system 200 using the file upload button with, optionally, a title pasted or written into the title box 604. For example, when the file upload button 608 is selected, a prompt appears requesting that a file be selected for uploading to the system. When the post button 606 is selected, the content in the file is posted to the system 200 in association with the title in the title box 604. The content posted using the post button 606 is saved in the database (along with the title) in association with the selected category. According to an embodiment, content posting means to upload content to the system 200 using the content posting page 600. It is understood that content and related titles are posted or uploaded to the system 200 is the same as content and related titles being transmitted to the system 200 for storing in the system's database 204 for publication and/or access. FIG. 6a is an exemplary screenshot of the content posting page 600.

Any type of fixed or publishable material in digital form can be posted to the system 200. For example, content can be text (e.g. articles), photographs, videos, audio recordings or any combination of different types of content saved to a digital file (e.g. in HTML, jpg, .txt formats).

Categories consist of general topics and are not client specific. Examples of categories include the following: construction, cosmetic, education, entertainment, hospitality, mining, real estate, etc.

The system administrator selects which categories are displayed in each member's page 400 and in which order they are displayed. This can be used to encourage members to post content into specific categories (e.g. categories that have received fewer content posting than required to fulfil client subscriptions). Alternatively, the categories that receive the least number of postings are automatically displayed in the members' pages 400. The administrator can manually adjust the categories that appear on the member page 400. By way of further example, the administrator can “lock” one or more categories so that the locked categories appear in the display of the member's page 400 until unlocked. Further, the administrator can allocate bonus awards or additional awards (beyond the normal allocation) to a member who posts content in specific categories which are selected by the administrator and which are each identified on the member page 400 as being a “bonus category”. According to an embodiment, the administrator can award discounts, credits or refunds to a client for who there is not enough content posted to satisfy its subscription.

### Content Publication

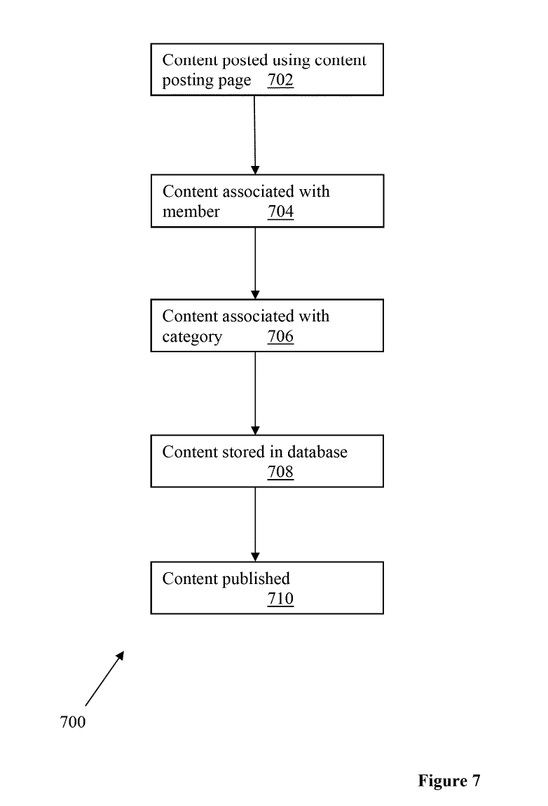

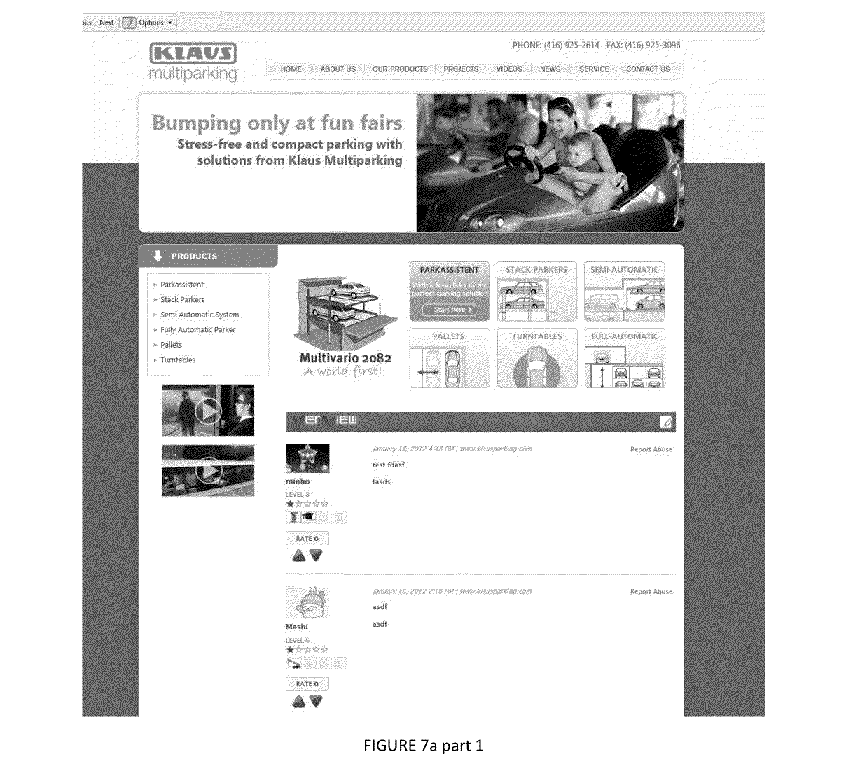

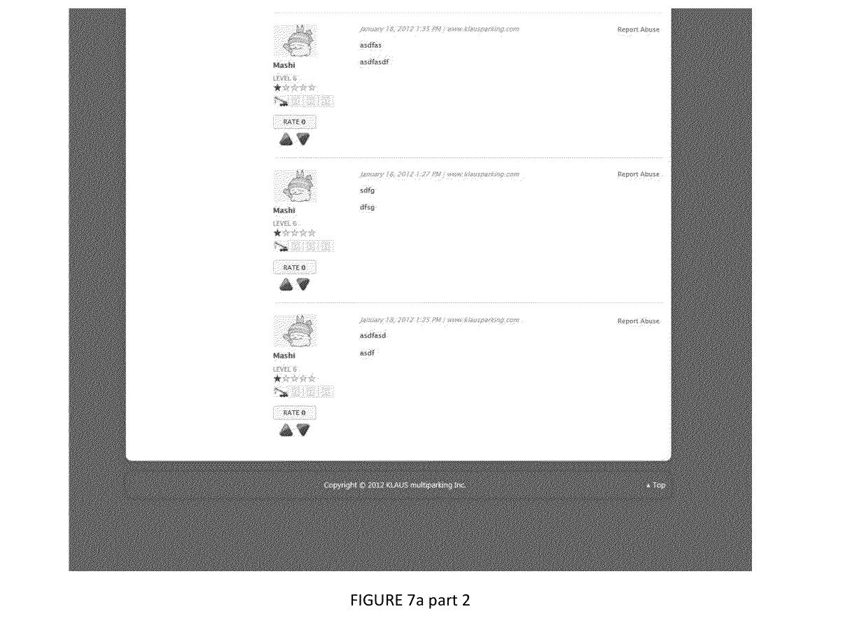

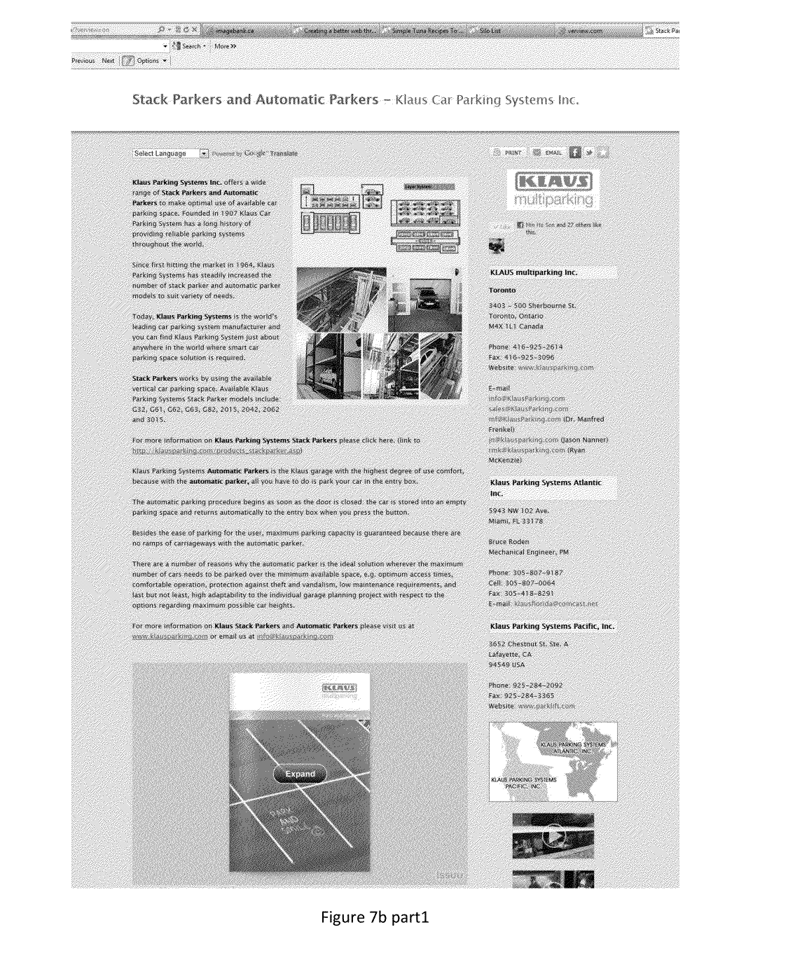

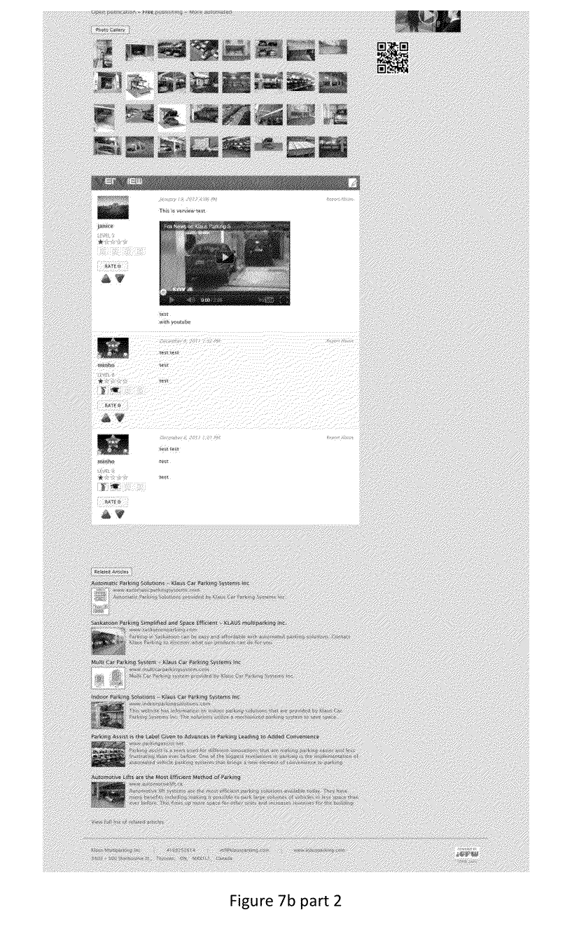

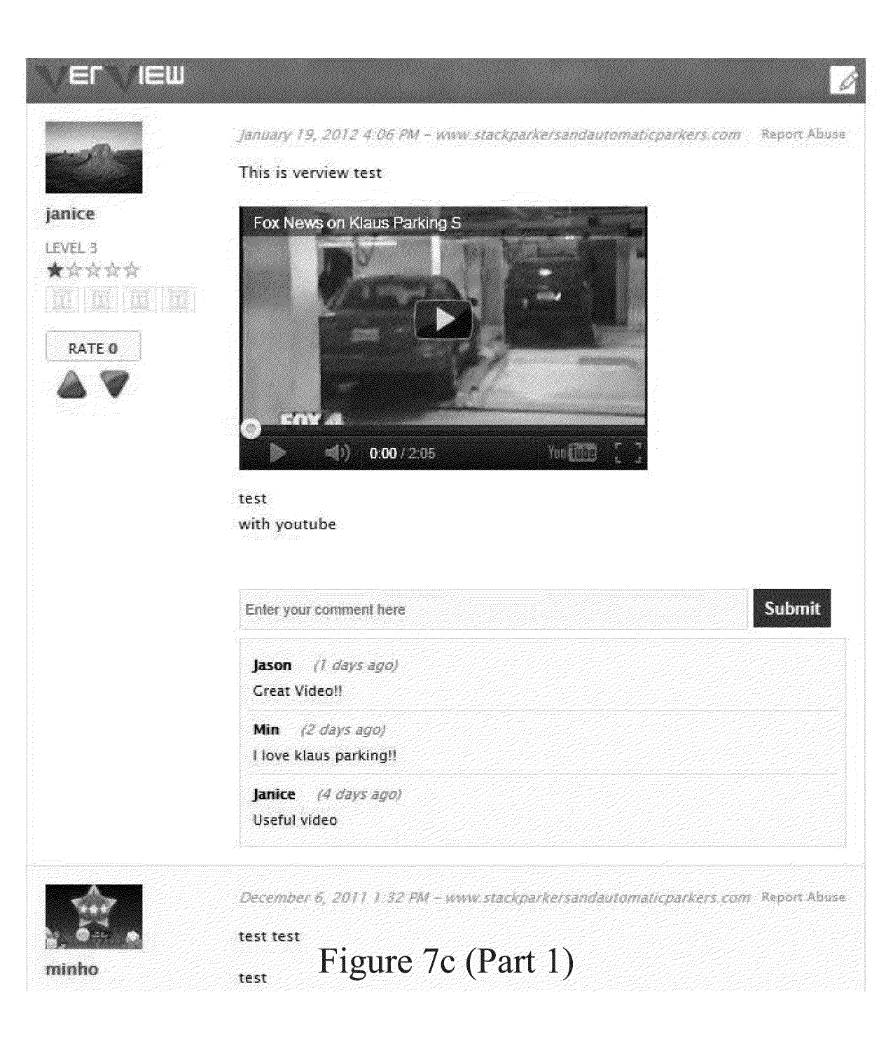

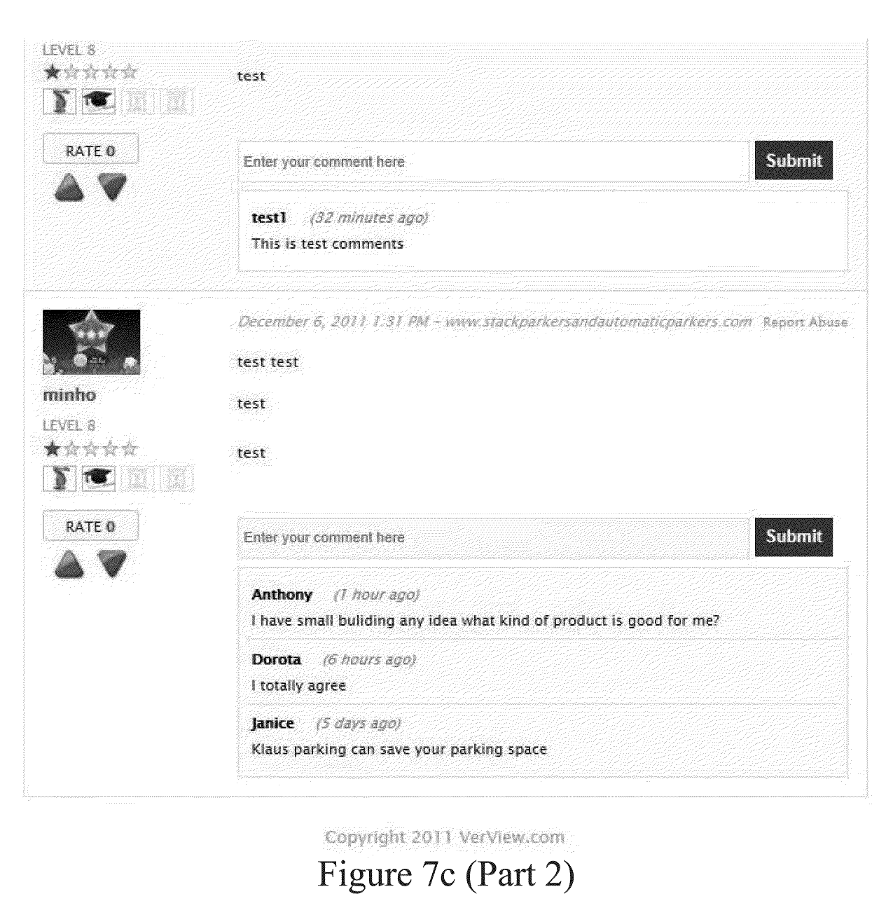

FIG. 7 shows a flow chart of the steps required to post content generally at 700. At step 702, content is posted to the system using the content posting page 600. At step 704 the posted content is associated with the identity of the member. For example, the system 200 (e.g. the central processor 202) identifies the member from the login information submitted to the member access page 400. At step 706, the posted content is associated with a category. For example, the system 200 (e.g. the central processor 202) associates the posted content with the category that was selected from the member page 400. At step 708 the content and is stored in the database 204 in association with the member and the category. For example, the central processor 202 saves the content and associated member and category in the database 204. At step 710, the system 200 (e.g. the central processor 202) publishes the content in one or more of the following three ways:
a. The content is transmitted to embedded plug-ins on clients' webpages. Each time content is transmitted to an embedded plug-in, the plug-in displays content on the client's webpage. For example, a client will be provided with code to embed on its webpage which will cause the webpage to access and display selected content in one or more specific categories from the system 200. The specific categories are those that the client has subscribed to. Alternatively, the content in the specific categories will be transmitted from the system 200 to the client's webpage for display. According to an embodiment, multiple different content postings are displayed on the client's webpage. FIG. 7a is a screenshot showing an exemplary client page with published content.
b. The system 200 creates and publishes a separate webpage for a client. This separate webpage can be hosted at the system 200, for example. All content for that client's selected categories is published on that client's webpage. Optionally, contact information and other client related information (such as logos and descriptions of operations) can be displayed in the webpage. FIG. 7b is a screenshot showing an exemplary webpage for a client.
c. The system 200 creates and publishes a separate webpage for the content. This separate webpage can be hosted at the system 200, for example. The webpage does not display any reference to any clients. FIG. 7c is a screenshot showing an exemplary webpage for the content. This separate webpage has a comments section in which the general public can provide comments in response to the content. Further, the general public can provide a rating to the posted content. For example, a person electing to rate the posted content will be requested to rate the content as positive (+1) or negative (−1). The ratings are transmitted to the system 200. The system 200 receives these ratings and stores the cumulative rating for each item of published content in association with the member in the database 204.

According to an embodiment, when content is published in any of the above three ways, the content is attributed to the member's character identification. Specifically, that member's character name and/or avatar appear next to the published content.

Categories can be temporarily locked by the system 200 on the members' pages 400. For example, the administrator can remove or prevent certain categories from appearing on one or more member's pages 400 (even when a search is conducted). This temporarily locking feature can be automated such that a certain category is locked after receive a threshold number of member postings until a pre-determined time period ends. This can be used by the system 200 to space out the posted content received on certain categories (e.g. in order to satisfy client subscription requirements).

According to an embodiment, upon receiving posted content in a certain category, the system 200 publishes the content to only one of a number of client pages who are subscribed to receive content for that category. In this way the system 200 can avoid publishing the same content to multiple client pages. The determination of which client page receives which content can be made manually by the administrator (using the administrator page) or automatically (e.g. pseudo-randomly).

### Clients Subscriptions

The system 200 allocates a subscription level to each client depending on the pre-determined subscription fee that the client has agreed to pay. The subscription level dictates the amount, category and frequency of content publications that the client will receive from the system 200. The subscription levels for each client are stored in the database 204. By way of example, different subscription levels can vary in the following features:
a. The number and selection of categories that the client will receive content posts from.
b. The number of content posts from each category that the client will receive in a selected time period (e.g. 2 content posts will be transmitted to the embedded plug-in in the client's webpage in the category of “investing” within each month for the next year).
c. The number (if any) of content posts from high-value categories that the client is entitled to. Certain categories are identified as high value by the system 200 (e.g. automatically or manually by an administrator) as a result of the nature of the content or of as a result of the number of content postings to that category. For example, subscription fees will be higher to receive content from high-value categories.
d. The number of members (if any) that a client can designate as “favourite”. For example, a client can designate 2, 3 or 4 members as favourites. A client can designate a member as favourite using the client page 500. It is contemplated that the number of members that can be designated as favourites depends on the client's subscription level
e. The number of articles (or other content), if any, that a client can designate as “favourite”. A client can designate an article as favourite using the client page 500. Articles that are designated as favourites stay on the top of the list of published articles on the client's webpage.
f. The number of members (if any) that a client can prohibit or ban from receiving content posts from. The client's selection of members that the client bans content from can be made through the client page 500.
g. Whether or not a separate page for content posted to a client's webpage will be created and maintained by the system 200.
h. Whether or not the system 200 will create a separate webpage for the content posted to a client's webpage.

It is recognized that alternative subscriptions, based on different combinations or permutations of the above list are possible to implement in the system 200. When a client initially subscribes to the system 200 the client provides the system 200 with the client's webpage, which the system 200 stores in the database 204.

Further, each of the above noted features can be changed or amended by the client in the client page 500. Further, a client can pay a one-time fee to receive published content posted to a certain category on an urgent basis. According to an embodiment, there is a selection button next to each category listing in the client page 500 that when selected signifies that the category is to be considered urgent and that the client requires content posted to that category on an urgent basis. For example, a client can pay a set fee to receive content within 24 hours on a category selected by the client. Similarly, a client can pay a one-time fee to receive content posted to a new and/or temporarily created category. For example, the system 200 can automatically create (or the administrator can manually create) a temporary category for a world event (such as a stock market crash or an international political confrontation) and clients can receive content posted to that temporary category within a set time period for a one-time fee.

According to an embodiment, each item of posted content is only published on one client webpage. For example, the member can select the category and the client for which the content will be published from the member page 400.

### Variable Characteristics

The variable characteristics of the members will now be described in more detail. The character identification comprises the member's identification information that is available to the public which includes a name and can also include an avatar. The avatar can be one of a pre-determined set of avatars that is only available to a member when that member's level has reached a certain point, for example.

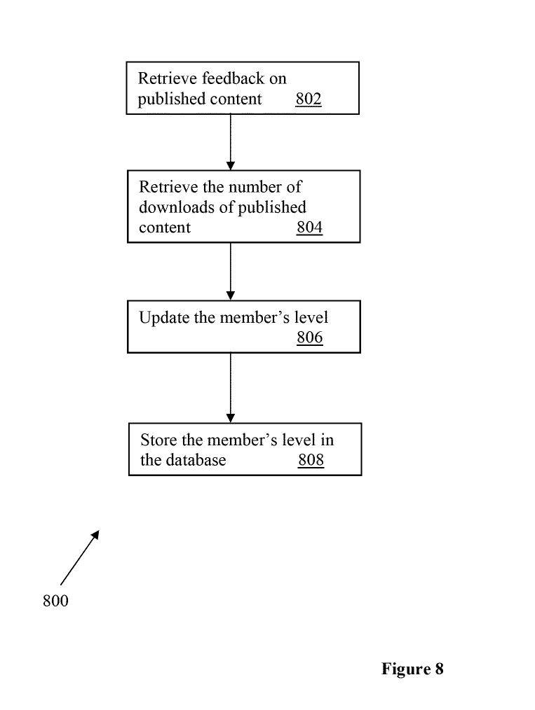

The member's level is a numerical value assigned to each member and is intended to reflect the historical skill of that member. FIG. 8 shows a flowchart of the steps for updating a member's level. At step 802 the system 200 retrieves from the database 204 the feedback received from the public and the clients in the form of cumulative ratings on published content, as noted above, for the member's content publications. At step 804 the system 200 retrieves from the database 204 the number of times a webpage containing particular content is downloaded or viewed. The system 200 maintains this information on an ongoing basis and stores it in the database 204. For example, each time a webpage containing published content is accessed the central processer 202 increments by one the number of times that content has been viewed. By way of further example, the number of times a webpage containing published content is viewed or downloaded can be maintained with a time boundary (e.g. the number of time the webpage has been downloaded in the past 30 days). At step 806 the member's level is updated according to the feedback and number of downloads of each of the member's posted content items. In an alternative embodiment, the member's level is updated each time any of that member's content is viewed and/or each time feedback is received on any of that member's content. Alternatively, the member's level is updated only when that member is entitled to receive an award (e.g. after each content posting or after each content posting of a sub-member). At step 808 the newly calculated or determined member's level is stored in the database 204. It is understood that the member's level is calculated or determined by the central processor 202 executing instructions stored on memory 203.

In an embodiment, the member's level is increased by one after a pre-determined threshold is reached of the sum of the ratings awarded to that member (or that member's published content), a certain percentage of sub-member's ratings and a certain percentage of special bonus benefits. It is understood that other values and bonus values can be used to evaluate whether to increase (or decrease) a member's level, such as the ratings of a member received by other members of a guild. In another embodiment, the sum of rewards received by the member is used to evaluate whether the member's level is to be increased. For example, if a member has received a pre-determined threshold number of rewards the member's level is increased by one or more. The number of rewards received by the member can also be used in connection with a percentage of special bonus benefits, a percentage of sub-member's ratings and the sum of the ratings awarded to that member to evaluate whether the member's level increases by one or more.

When a sub-member posts content that sub-member will receive a rating and that sub-member's level will be consequently updated. A change in the level of each sub-member who was invited by a member causes the member's level to change. For example, a percentage of a sub-member's reward, such as 5%, can be allocated to the member each time a sub-member receives a reward. Further a percentage of the sub-member's level can be allocated to the member, thereby boosting the member's level. However, after a member's sub-members have received a certain negative level (e.g. as the result of negative feedback on content publications) that member's entitlement to invite sub-member's can be revoked or that member's level can be lowered by a level commensurate with the sub-members' negative level.

There are certain categories to which a member can only post content if that member's level is at a certain number or higher. These categories can be pre-determined or can be identified by the system (or an administrator). As noted, the member can select a category to include in its list of category specializations. For example, if the member is carpenter they can select the carpentry category as their specialization. Further, as a member reaches a certain pre-set number of posts for a category, that member will automatically be assigned a specialization in that category. As a result of receiving a specialization, the member receives higher rewards in the category for which he or she has a specialization. Further, upon receiving specialization the member will receive an avatar that indicates the specialization. According to an embodiment the avatar appears in association with all of the member's published content. The specific level required to obtain a specialization can be different for each category. According to an embodiment, specialization in a category is granted once member has posted 100 articles in that category with an overall positive rating. In a further embodiment, a member who has posted 100 articles in a category with an overall positive rating will receive a specialization in a related category (as identified by the administrator).

After a member reaches certain levels, that member is entitled to certain benefits. For example, after a member reaches level 50 that member will have the ability to invite sub-members and after a member reaches level 100 that member will have the ability to invite a client. If the member invites a sub-member and that sub-member agrees to become a member, the system 200 will store this information in the database 204 such that the member will be associated with the sub-member. The system 200 can place further restrictions on a member's ability to invite sub-members to join the system 200. For example, the member is required to have posted over 100 articles (or other types of content) or in a further example, the member is required to have a cumulative positive rating of plus-50 on all posted content to be entitled to invite sub-members.

After a member reaches certain special achievements, that member will have access to certain features. For example, after posting a threshold number of articles (or other content) on a specific category or after maintaining a threshold level after posting a threshold number of content the member will have the ability to invite more sub-members or to invite clients. If a member invites a client and that client accepts (i.e. the client subscribes to the system 200), then that member will receive a special bonus reward, for example. By way of further example, if the member invites a client and the client accepts (i.e. subscribes to the system 200) the member will receive an increase to its level and in certain embodiments the member will receive an increase in its level depending on the subscription level that the client uses. The member's level can be initially set to a certain value (e.g. zero). Or, alternatively, if the member is invited by another member the invited member's level can be initially set at a level reflective of the inviting member (e.g. as a percentage of the inviting member's level).

According to an embodiment, after a member has posted a threshold number of content items to the system 200, each subsequent posting or publication from that member on the system 200 will have less of an effect on the member's level. Thus, a member with a longer history of content posting will not be affected by a negatively rated publication as much as the member would be with a shorter history of content posting. By way of further example, the member's threshold number of postings for altering the effect of future ratings is only triggered if the member's rating is above a certain threshold level.

### Rewards

Members receive rewards for posting content which is dependent on a number of factors including the member's level, the ratings from the public, ratings from clients, whether the category is high-level and whether the category is a temporary world event category. Generally a member receives rewards after content is published by the system 200 or after content is posted to the system 200.

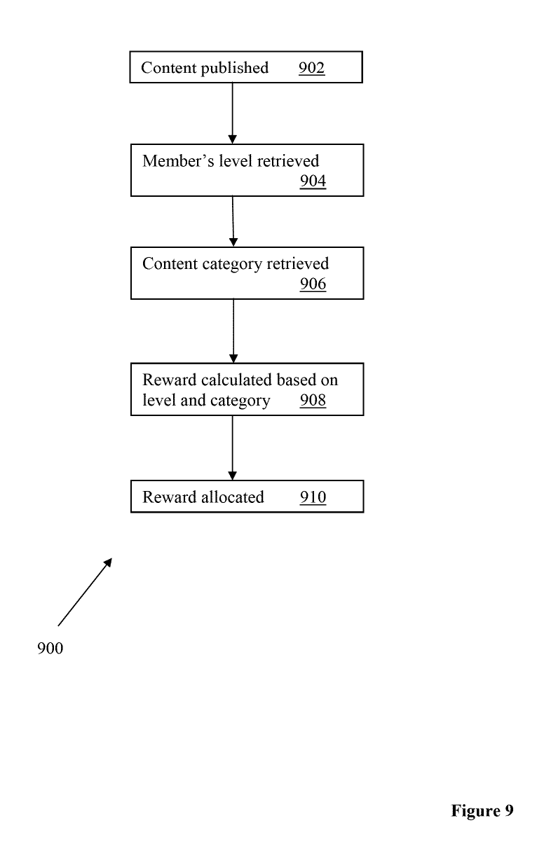

FIG. 9 is a flow chart showing the rewards a member receives for posting content. At step 902 the member's content is published, as described above. At step 904 the system 200 retrieves the member's level from the database 204. At step 906, the system 200 retrieves the category of the published content from the database 204. At step 908, the reward is calculated based on the member's level and/or the category of the content. According to an embodiment, a member with a level of 10 receives a smaller reward per posted or published content item than a member with a level of 20. Further, articles in certain categories (i.e. high-value categories as identified by the system 200 or administrator) provide an increased reward over other categories for each post or publication. The amount of reward a member receives for posted or published content is also changed by the ratings received for that posting. A member can also receive an increased reward for a posting in a temporary or world event category. For example, if a world event occurs and the system 200 (or administrator) creates a temporary category for that event, posting content in that event will generally lead to a higher than normal reward. In a further embodiment, if a member is a favourite of a client, that member receives an increased reward for posting content to a category that the client subscribes to. Finally, at step 910, the member's reward is allocated to that member.

According to an embodiment, rewards are monetary payments paid out at the end of each month. The rewards are paid out from the system 200 to the member. In an embodiment, the rewards are held by the system for a certain period of time (e.g. 1 month) before being paid out to the member. It is understood that rewards can be paid out after longer time intervals. It is also understood that rewards can be other than monetary payments. For example, rewards can be increased membership privileges, consumer items, coupons for certain businesses, etc.

In addition to receiving rewards in response to posting content, various chance rewards are given to the members by the system 200. For example, a chance reward can be offered to one of the members (e.g. randomly selected) who posted content in a certain category within the last month. The member's rating effects the value of the rewards received for posting content to a certain category. For example, a member with a higher cumulative amount of ratings will receive a higher reward than a member with a lower cumulative amount of ratings with both members at the same level. Similarly, the likelihood of receiving a chance rewards increases when a member has a higher cumulative rating. A member's level, on the other hand, effects the value of the chance reward received (with a higher level corresponding to a higher value of reward).

The system 200 (or the administrator) sets minimum level values for each category so that only members with a level at or above that minimum can post content to that category. Similarly, the system 200 (or the administrator) sets requirements on certain categories such that members must have a specialization in that category or in a related category in order to post content to that category. These category features (e.g. the minimum level for posting and any specialization requirement) are stored in the database 204.

Further, members can receive special bonus benefits. For example, a member can receive a “buff” bonus state. This can be received via a random reward or can be purchased from the system 200. A “buff” bonus state, once activated, provides a time limited increased amount of rewards. For example, a member whose buff bonus state is activated received a 10% increase in rewards received over the next 6 hours. The buff bonus state can be such that it is activated automatically by the system 200 (e.g. on receipt of the bonus reward) or can be activated by the member (e.g. when the buff state is purchased).

According to an embodiment, rewards can be collected as points by the member in the system 200. The points can be exchanged for money, items (e.g. iPhone™, television, cruise trip, etc.) or can be used to purchase further achievements or features of the system 200. For example, points can be used to increase a member's level or can be used to purchase special abilities such as buff bonus states of certain durations.

### Method for Managing Content

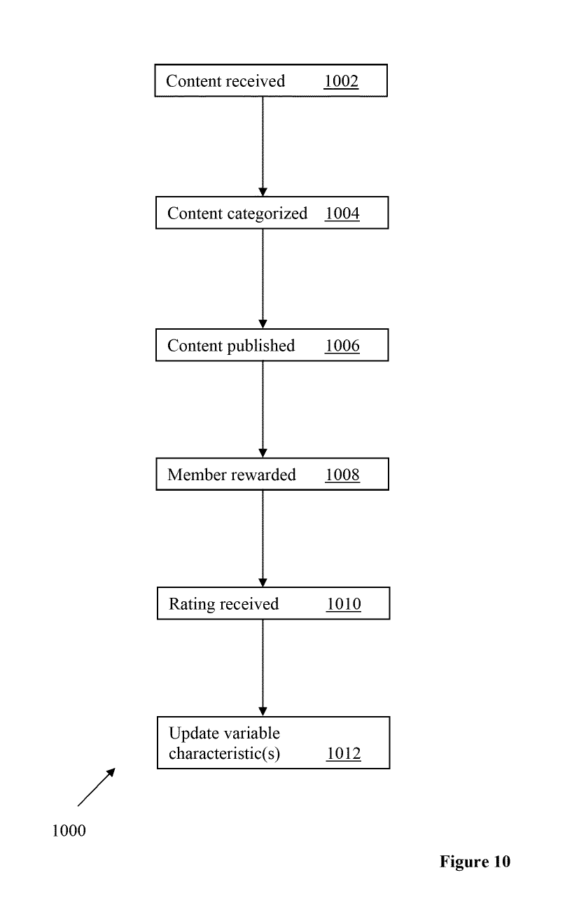

Referring to FIG. 10, a flow chart showing a computer implemented method of managing content is illustrated at numeral 1000. The method 1000 may be implemented using the database 204 and/or one or more of the pages described above.

At step 1002, content is received from a member. The content is transmitted from a computer 102 across the communications network 106 to the system 200. For example, the content is posted using the member's page and is saved in the database 204.

At step 1004, the content is categorized into one of a pre-existing list of content categories. The member selects the category from the member page in association with which the content will be saved. The category is then transmitted across the communications network 106 to the system 200. The system 200 then stores the content in association with the transmitted category in the database 204.

At step 1006, the content is published. For example, the system 200 publishes the content in any of the three ways described above.

At step 1008, the member is rewarded for the published content. As explained in detail above, this reward is commensurate with or depends on the level assigned to that member by the system 200. The level can depend on a number of features, such as whether the member is a specialist in a particular category and whether the member has a history of positively rated content publications.

At step 1010, a rating on the content is received. For example, a rating from a member of the public on content posted on a content webpage is received at the system 200. By way of further example, a rating from a client on the content posted on the client's webpage is transmitted from the client to the system 200 through the client page 500 of the GUI. The system 200 could receive both types of ratings on the same content (assuming the content was published on both pages)

At step 1012, one or more of the member's variable characteristics is updated to reflect the one or more ratings received on the content. As noted above, ratings can be received from the public on a published webpage of content or can be received from the client through the client page 500. According to an embodiment, the ratings are +1 for a positive rating and −1 for a negative rating. The ratings are transmitted (e.g. across the communication network 106) to the system 200 and stored in the database 204 in association with the member's identification. The system 200 also records a cumulative rating by adding together all of the ratings that that member has received over time. For example, the system 200 increases the member's level by one point as a result of a rating of positive 3 received by the system 200 from the content webpage. It is understood that alternative ways of incorporating the ratings from the public and from the client as a result of a member's published content can be used.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1. A computer implemented method for managing content, comprising:
receiving the content at a server, the content transmitted over a communication network from a member, the member having a profile comprising a plurality of variable characteristics, the profile stored in a database coupled to the server;
categorizing the content into one of a pre-existing list of content categories and storing the categorized content into the database;
publishing the content;
receiving one or more ratings in response to publishing the content;
updating one or more of the variable characteristics in the database to reflect the one or more ratings; and
allocating a reward to the member for the published content, the reward commensurate with one or more of the plurality of variable characteristics.

2. The method of claim 1 wherein the step of publishing the content comprises at least one of:
transmitting the content from the system to a client web page for publication;
publishing the content on a web page accessible over the communications network; and
publishing the content on a web page associated with the client, the web page accessible over the communication network.

3. The method of claim 1, wherein the variable characteristics comprise a character identification and a level.

4. The method of claim 3, further comprising publishing the character identification together with the content.

5. The method of claim 3, wherein the variable characteristics further comprise an avatar selected from a list of pre-determined avatars, the avatar of a member corresponds with the level of the member.

6. The method of claim 1, wherein the step of receiving a rating comprises receiving a positive or negative rating transmitted over the communication network in direct response publishing the content.

7. The method of claim 1, further comprising
receiving a member rating from a client, the member rating comprising a positive or negative rating of the member; and
updating one or more of the variable characteristics of the member in response to receive the member rating, the updating commensurate with the member rating.

8. The method of claim 3, wherein the step of updating comprises increasing the member's level in response to a positive rating and decreasing the member's level in response to a negative rating, and wherein the reward is commensurate with the member's level.

9. The method of claim 8, further comprising providing a chance reward to a selected member, wherein the probability of a member being selected is commensurate with one or more variable characteristics of that member.

10. The method of claim 1, further comprising adding a category to the list of pre-existing categories.

11. The method of claim 1, wherein the step of categorizing comprises one of receiving a category selection from the member and allocating the content to a category.

12. The method of claim 11, wherein one or more categories are restricted from a member's selection when the member has a level lower than a pre-determined cut-off level.

13. The method of claim 1, further comprising:
receiving further content at the server, the further content transmitted over a communication network from a sub-member, the sub-member associated with the member;
categorizing the further content into one of a pre-existing list of content categories and storing the categorized content into the database;
publishing the further content;
receiving one or more ratings in response to publishing the further content;
rewarding the member for the step of publishing the further content, the reward commensurate with the one or more ratings in response to publishing the further content.

14. A system for managing content, comprising:
a server for receiving content, the content transmitted over a communication network from a member, the member having a profile comprising a plurality of variable characteristics;
a database coupled to the server for storing the member's profile, the database for storing a category in association with the content, the category one of a pre-existing list of content categories;
a central processor in communication with the server for transmitting data therebetween;
a memory coupled to the central server, the memory having instructions and data stored thereon for execution by the central processor to configure the central processor to:
publish the content;
receive one or more ratings in response to the published content and update one or more of the variable characteristics in the database to reflect the one or more ratings; and
allocate a reward to the member for the published content, the reward commensurate with one or more of the plurality of variable characteristics.

15. The system of claim 14, wherein the variable characteristics comprise a character identification and a level.

16. The system of claim 15, wherein the central processor is further configured to publish the character identification together with the content.

17. The system of claim 14, wherein the central processor is further configured to accumulate the ratings received and wherein the variable characteristics of the member are updated commensurate with the cumulative rating.

18. The system of claim 17, wherein the central processor is further configured to allocate a chance reward to a selected member, wherein the probability of a member being selected is commensurate with one or more variable characteristics of that member.

19. The system of claim 14, wherein the central processor is further configured to:
receive further content, the further content transmitted over a communication network from a sub-member, the sub-member associated with the member;
categorize the further content into one of a pre-existing list of content categories and store the categorized content into the database;
publish the further content;
receive one or more ratings in response to publishing the further content; and
allocate a reward to the member for the published further content, the reward commensurate with the one or more ratings in response to publishing the further content.

20. A computer program product having computer readable code embodied therein, for execution by a central processor for configuring the central processor to:
receive content at a server, the content transmitted over a communication network from a member, the member having a profile comprising a plurality of variable characteristics, the profile stored in a database coupled to the server;
categorize the content into one of a pre-existing list of content categories and storing the categorized content into the database;
publish the content;
receive one or more ratings in response to publishing the content;
update one or more of the variable characteristics in the database to reflect the one or more ratings; and
allocate a reward to the member for the published content, the reward commensurate with one or more of the plurality of variable characteristics.
